(19) United States
(12) Patent Application Publication
(10) Pub. No.: US 2006/0028502 A1
(43) Pub. Date: Feb. 9, 2006

(54) METHOD FOR OPTIMIZING INK JETTED FROM NOZZLES OF A PRINTHEAD OF A PRINTER

(76) Inventors: Cheng-Lung Lee, Taipei City (TW); Hsieh-Sheng Liao, Yun-Lin Hsien (TW)

Correspondence Address: NORTH AMERICA INTELLECTUAL PROPERTY CORPORATION, P.O. BOX 506, MERRIFIELD, VA, 22116, US

(21) Appl. No.: 11/161,438

(22) Filed: Aug. 3, 2005

(30) Foreign Application Priority Data
Aug. 5, 2004 (TW) 093123516

(51) Int. Cl. B41J 29/38; B41J 2/165; B41J 2/05

(52) U.S. Cl. 347/17; 347/35; 347/60

(57) ABSTRACT

A method for optimizing ink jetted from nozzles of a printhead of an ink jet printer. Before printing a swath, the nozzles of the printhead jet a predetermined number of ink drops towards an absorption substance at the maintenance station of the printer. The predetermined number corresponds to a swath density of the swath to be printed to preheat a chip of the printhead to an optimal temperature before printing.

### BACKGROUND OF THE INVENTION

1. Field of the Invention

The present invention relates to a method for optimizing ink jetted from nozzles of a printhead of a printer. More particularly, a method for preheating the nozzles of the printhead of the printer by jetting ink before printing a swath is disclosed.

2. Description of the Prior Art

Ink jet printers provide good printing quality at a fair price and as a result, have become the most popular type of printing equipment. With the quick advancement in technology, better printing quality has been a target that information industrial circles work to achieve.

A general printhead maintenance device comprises a wiper, a printhead cap, and an absorption substance. The wiper is used to wipe remaining ink from the printhead. The printhead cap is used to cap the printhead to avoid remaining ink drying on the printhead and blocking the nozzles when the printhead returns to its original position. The absorption substance is used to absorb ink jetted by the printhead when cleaning the nozzles.

Take a thermal bubble inkjet printing technology for example. Before printing and during printing, the printhead maintenance device utilizes the wiper to clean the nozzles of the printhead to ensure good printing quality. When the printhead maintenance device performs cleaning, the printhead is moved to a maintenance station of the printer and then the wiper is used to wipe remaining ink from the printhead. After that, if printing is to occur, the ink jet chip must be heated up to a threshold temperature.

When printing higher swath densities, the temperature variation of the ink jet chip is larger. That is, the temperature of the ink jet chip grows larger after printing. On the contrary, for lower swath densities, the temperature variation of the ink jet chip is smaller. In other words, when printing lower swath densities, the temperature of the ink jet chip increases during printing, but the increase is less than the increase when printing higher swath densities. Of course, if the threshold temperature T_{threshold} of the printhead is set to a lower temperature, this can ensure that the temperature of the ink jet chip does not exceed the maximum temperature Tₘₐₓ at which the ink jet chip can operate normally. However, when printing lower swath densities using such a printhead, after finishing printing, the temperature of the ink jet chip is much lower than the maximum temperature Tₘₐₓ so that printing quality is poor and standby time is increased due to the smaller temperature variation and the lower threshold temperature T_{threshold}. If the threshold temperature T_{threshold} is set to a higher temperature in order to optimize printing quality, the temperature variation of the ink jet chip is too large when printing higher swath densities. What is worse, during printing, the temperature of the ink jet chip exceeds the maximum temperature Tₘₐₓ, damaging the printhead.

### SUMMARY OF THE INVENTION

It is therefore a primary objective of the claimed invention to provide a method for optimizing ink jetted from nozzles of a printhead to solve the above-mentioned problem.

The claimed invention provides a method for optimizing ink jetted from nozzles of a printhead. The method includes the nozzles of the printhead jetting a predetermined number of ink drops towards an absorption substance at a maintenance station of the printer before printing a swath. The predetermined number corresponds to a swath density of the swath to be printed to preheat a chip of the printhead to an optimal temperature T_{threshold} before printing.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart of the present invention.

FIG. 2 is a diagram of a printer according to the present invention.

FIG. 3 is a graph of threshold temperatures with different swath densities versus the number of ink drops.

### DETAILED DESCRIPTION

The method of the present invention uses nozzles of a printhead to jet ink at room temperature and stores the number of ink drops jetted in a memory, the number corresponding to a swath density. When a user utilizes a printer, before printing, the ink jet chip obtains the number of ink drops from the memory according to the swath density to be printed. Therefore, before printing, the nozzles jet the obtained number of ink drops at the maintenance station of the printer to preheat the ink jet chip to the threshold temperature T_{threshold} and then printing is performed. The present invention can be implemented in a thermal bubble inkjet printer, or other printing technology, which might increase the temperature of the ink jet chip during printing.

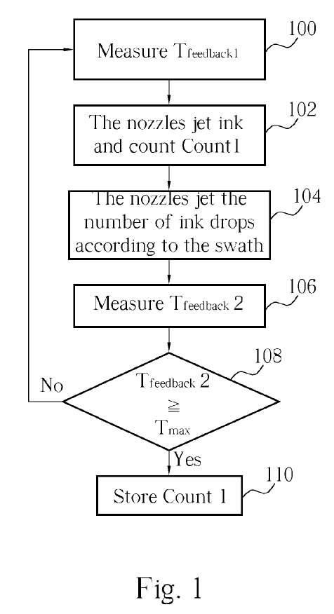

Please refer to FIG. 1, which is a flowchart of the present invention to research the number of ink drops to preheat the ink jet chip to the threshold temperature T_{threshold}. The steps are as follows:

Step 100: Use a thermal sensor to measure the present feedback temperature T_{feedback1} of the ink jet chip.

Step 102: Use a logic unit to control the nozzles of the ink jet chip to jet ink at the maintenance station of the printer. The number of ink drops, Count1, is counted while the nozzles are jetting ink.

Step 104: After finishing Step 102, the nozzles jet the number of ink drops according to the swath density to be printed.

Step 106: After finishing Step 104, the thermal sensor is used to measure the feedback temperature T_{feedback2} of the ink jet chip.

Step 108: Compare the feedback temperature T_{feedback2} and the maximum temperature Tₘₐₓ. If T_{feedback2} is approximately equal to Tₘₐₓ, go to step 110. Otherwise, when the feedback temperature decreases approximately to T_{feedback1}, then increase Count1 and go back to Step 100.

Step 110: The threshold temperature T_{threshold} is set to T_{feedback1}, and Count1 is the number of ink drops to preheat the ink jet chip to T_{threshold} and is stored in a memory.

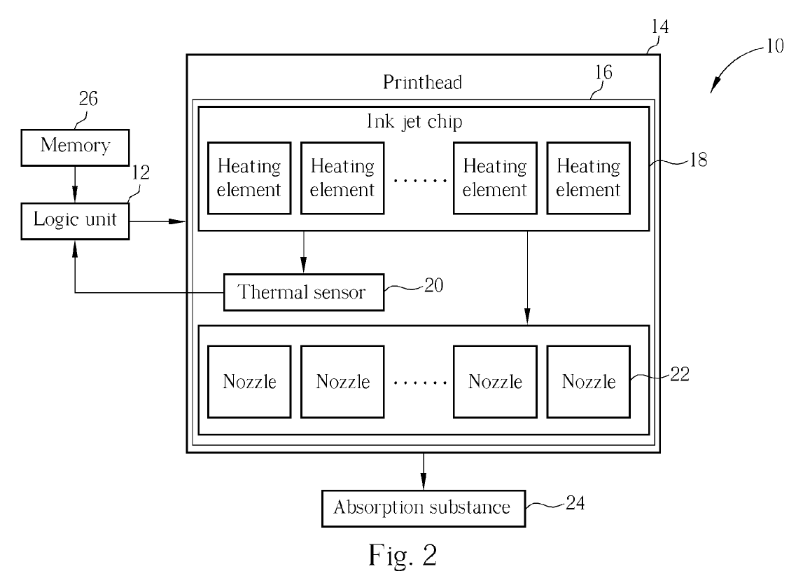

Please refer to FIG. 2, which is a diagram of the printer 10 based on the present invention. The printer 10 comprises a logic unit 12, a printhead 14, a memory 26, and an absorption substance 24 for absorbing ink, such as a sponge. The printhead 14 includes an ink jet chip 16 having a plurality of heating elements 18, a thermal sensor 20, and a plurality of nozzles 22. The logic unit receives the number of ink drops from the memory 26 to control the nozzles 22 of the printhead 14 to jet ink towards the absorption substance 24 so that the ink jet chip 16 is preheated to the threshold temperature.

The second embodiment of the present invention is described as follows. The logic unit 12 obtains the threshold temperature corresponding to the swath density from the memory 26. The nozzles 22 jet ink at the maintenance station of the printer 10 until the feedback temperature T_{feedback} measured by the thermal sensor 20 is equal to the threshold temperature and then the printer 10 performs printing.

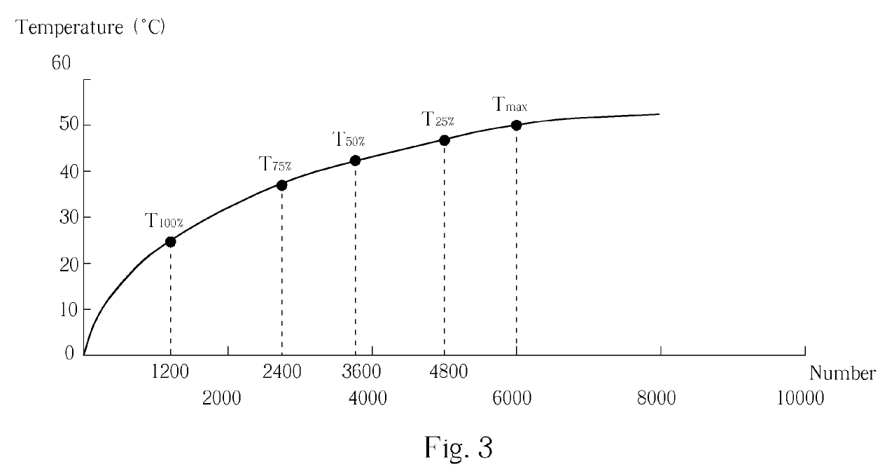

Please refer to FIG. 3, which is a graph of threshold temperatures with different swath densities versus the number of ink drops. As shown in FIG. 3, the maximum temperature Tₘₐₓ at which the ink jet chip 16 can operate normally is about 50 degrees centigrade. If the swath density of the swath is 50%, the optimal threshold temperature is about 42˜43 degrees centigrade and the number of ink drops is 3600. Hence, before printing, the nozzles 22 of the printhead 14 must continuously jet ink drops at the maintenance station 3600 times so that the temperature of the ink jet chip 16 increases approximately to the temperature T_{50%} and thereby ensure that the temperature of the ink jet chip 16 does not exceed Tₘₐₓ during printing. When the swath with 50% swath density is printed at temperature T_{50%}, the temperature of the ink jet chip 16 can approximately increase to the maximum temperature Tₘₐₓ after finishing printing so that the purpose of optimizing printing quality is achieved.

Additionally, the second embodiment of the present invention uses the nozzles 22 to continuously jet ink at the maintenance station and uses the thermal sensor 20 to measure the feedback temperature T_{feedback} of the ink jet chip 16 until the feedback temperature T_{feedback} grows to the threshold temperature. For instance, if the swath with 50% swath density is printed, the nozzles 22 jet ink continuously while the thermal sensor 20 measures the feedback temperature T_{feedback} of the ink jet chip 16. The nozzles 22 jet ink until the feedback temperature T_{feedback} grows to the threshold temperature T_{50%} (about 42˜43 degrees centigrade). After increasing to the threshold temperature T_{50%}, printing is performed.

The first embodiment of the present invention can re-execute step 100 to 110 when booting the printer 10 and thereby reduce the negative effect of environment for printing quality.

Compared to the prior art, the present invention utilizes the nozzles 22 to jet ink to preheat the printhead 14 so that the ink jet chip 16 does not exceed the maximum temperature Tₘₐₓ at which the ink jet chip can operate normally after finishing printing. Therefore, the present invention can achieve the purpose of optimizing printing quality. In addition, the temperature of the ink jet chip 16 does not exceed the maximum temperature Tₘₐₓ if the method of the present invention is used. Therefore, the present invention can solve the prior art problem that no matter which swath density is printed, the ink jet chip must be preheated to the same threshold temperature before printing. The present invention sets different threshold temperatures for different swath densities to avoid the prior art problems.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for optimizing ink jetted from a printhead of a printer, the printhead comprising an ink jet chip, the ink jet chip having a plurality of nozzles for ink jet printing, the method comprising:
before printing a swath, the nozzles jetting a predetermined number of ink drops to preheat the ink jet chip to an optimal temperature, the predetermined number corresponding to a swath density of the swath.

2. The method of claim 1 wherein the nozzles jet the predetermined number of ink drops towards an absorption substance at a maintenance station of the printer.

3. The method of claim 1 further comprising counting number of ink drops jetted by the nozzles when the ink jet chip is preheated to the optimal temperature, and setting the number as the predetermined number before printing the swath.

4. The method of claim 3 wherein the number of ink drops jetted by the nozzles is counted when the ink jet chip is preheated from room temperature to the optimal temperature.

5. The method of claim 3 comprising:
measuring a first feedback temperature of the ink jet chip;
the nozzles jetting a default number of ink drops;
the nozzles of the ink jet chip jetting the number of ink drops corresponding to the swath density of the swath after finishing jetting the default number of ink drops;
measuring a second feedback temperature of the ink jet chip after finishing jetting the number of ink drops corresponding to the swath density of the swath; and
setting the default number as the predetermined number if the second feedback temperature is approximately equal to a maximum temperature at which the ink jet chip can operate normally; otherwise, increasing the default number, and after the temperature of the ink jet chip decreases to the first feedback temperature, repeating jetting the increased default number of ink drops, jetting the number of ink drops corresponding to the swath density of the swath, measuring the second feedback temperature, and comparing the second feedback temperature with the maximum temperature.

6. A method for optimizing ink jetted from nozzles of a printhead of a printer, the printer comprising an ink jet chip, the ink jet chip having a plurality of nozzles for ink jet printing, the method comprising:
before printing a swath, the nozzles jetting ink until the temperature of the ink jet chip increases to an optimal temperature corresponding to a swath density of the swath.

7. The method of claim 6 wherein the nozzles jet ink towards an absorption substance at a maintenance station of the printer.

8. A printer capable of optimizing ink jetting comprising:
a printhead having an ink jet chip, the ink jet chip having a plurality of nozzles for ink jet printing; and
a logic unit for controlling the nozzles of the ink jet chip to jet a predetermined number of ink drops so as to preheat the ink jet chip to an optimal temperature before printing a swath, the predetermined number corresponding to a swath density of the swath.

9. The printer of claim 8 further comprising an absorption substance placed at a maintenance station of the printer, wherein the logic unit controls the nozzles of the ink jet chip to jet the predetermined number of ink drops ink towards the absorption substance at the maintenance station of the printer according to the swath density of the swath to preheat the ink jet chip to the optimal temperature before printing the swath.

10. The printer of claim 9 wherein the absorption substance is a sponge.

11. The printer of claim 8 further comprising a memory, wherein the logic unit further controls the nozzles of the ink jet chip to jet ink and counts the number of ink drops jetted while the temperature of the inkjet chip increases to the optimal temperature, and the memory stores the number of jetted ink drops when the temperature of the ink jet chip increases to the optimal temperature.

12. A printer capable of optimizing ink jetting comprising:
a printhead having an ink jet chip, the ink jet chip having a plurality of nozzles for ink jet printing; and
a logic unit for controlling the nozzles of the ink jet chip to jet ink until the temperature of the ink jet chip increases to an optimal temperature corresponding to a swath density of a swath before printing the swath.

13. The printer of claim 12 further comprising an absorption substance placed at a maintenance station of the printer, wherein the logic unit controls the nozzles of the ink jet chip to jet ink towards the absorption substance at the maintenance station of the printer until the temperature of the ink jet chip increases to the optimal temperature corresponding to the swath density of the swath before printing the swath.

14. The printer of claim 13 wherein the absorption substance is a sponge.
